(19) United States
(12) Patent Application Publication
(10) Pub. No.: US 2010/0303355 A1
(43) Pub. Date: Dec. 2, 2010

(54) IMAGE PROCESSING APPARATUS, IMAGE PROCESSING METHOD, AND IMAGE PROCESSING PROGRAM

(75) Inventor: Hideru IKEDA, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: Olympus Corporation, Tokyo (JP)

(21) Appl. No.: 12/783,587

(22) Filed: May 20, 2010

(30) Foreign Application Priority Data
May 28, 2009 (JP) 2009-128791

(51) Int. Cl. G06K 9/00

(52) U.S. Cl. 382/169

(57) ABSTRACT

The invention provides an image processing apparatus, image processing method, and image processing program that perform gradation correction processing with reduced color unevenness, even for an image containing a low-contrast region, with a simple configuration. A first gradation-distribution calculating unit divides the gradation width of an input image signal into a plurality of gradation sections and calculates a first histogram showing the frequency of pixel values in each gradation section; a decision unit decides whether the image contains a low-contrast region on the basis of a feature component signal related to the contrast of the image; a second gradation-distribution calculating unit calculates, using the first histogram, a second histogram which is divided into a greater number of gradation sections than the first histogram; and a gradation correction unit performs gradation correction processing using the second histogram when it is determined that the image contains a low-contrast region, and performs gradation correction processing using the first histogram for other images.

### BACKGROUND OF THE INVENTION

1. Field of the Invention

The present invention relates to gradation correction processing of an image signal, used when correcting the gradation of contrast etc. in an image, and in particular relates to an image processing apparatus and an image processing method that perform gradation correction processing using a histogram of an image signal.

This application is based on Japanese Patent Application No. 2009-128791, the content of which is incorporated herein by reference.

2. Description of Related Art

In image signal processing performed in image acquisition systems of current digital cameras, gradation correction processing is usually performed to correct contrast gradation etc. One method for gradation correction processing involves calculating a gradation conversion characteristic using a histogram related to the pixel values in the image signal. One example of such gradation correction processing is the technique disclosed in Japanese Unexamined Patent Application, Publication No. 2006-195651, which involves dividing an image into a highlight area containing a person or the like and a background area that does not contain a person or the like; calculating a histogram representing the frequency of pixel values in each divided region; and performing gradation correction processing with a gradation conversion characteristic corresponding to each region, obtained on the basis of this histogram.

### BRIEF SUMMARY OF THE INVENTION

The present invention employs the following solutions.

A first aspect of the present invention is image processing apparatus including a first gradation-distribution calculating unit that divides the gradation range of an input image signal into a plurality of gradation sections and that calculates a first histogram showing the frequency of pixel values in each gradation section; a decision unit that detects a feature component signal related to the contrast of an image from the input image signal and that determines, on the basis of the feature component signal, whether the image contains a low-contrast region whose contrast is lower than a prescribed threshold; a second gradation-distribution calculating unit that calculates, using the first histogram, a second histogram in which the gradation range of the input image signal is divided into a greater number of sections than the number of gradation sections in the first histogram; and a gradation correction unit that performs gradation correction processing using the second histogram when it is determined by the decision unit that the image contains a low-contrast region, and that performs gradation correction processing using the first histogram when it is determined that the image does not contain a low-contrast region.

A second aspect of the present invention is a program storage medium storing an image processing program that causes a computer to execute first gradation-distribution calculation processing for dividing the gradation range of an input image signal into a plurality of gradation sections and calculating a first histogram showing the frequency of pixel values in each gradation section; decision processing for detecting a feature component signal related to the contrast of an image from the input image signal and for determining, on the basis of this feature component signal, whether the image contains a low-contrast region whose contrast is lower than a prescribed threshold; second gradation-distribution calculation processing for calculating, using the first histogram, a second histogram in which the gradation range of the input image signal is divided into a greater number of sections than the number of gradation sections in the first histogram; and gradation correction processing for performing gradation correction processing using the second histogram when it is determined in the decision processing that the image contains a low-contrast region, and for performing gradation correction processing using the first histogram when it is determined that the image does not contain a low-contrast region.

A third aspect of the present invention is an image processing method including a first gradation-distribution calculation step of dividing the gradation range of an input image signal into a plurality of gradation sections and calculating a first histogram showing the frequency of pixel values in each gradation section; a decision step of detecting a feature component signal related to the contrast of an image from the input image signal and determining, on the basis of this feature component signal, whether the image contains a low-contrast region whose contrast is lower than a prescribed threshold; a second gradation-distribution calculation step of calculating, using the first histogram, a second histogram in which the gradation range of the input image signal is divided into a greater number of sections than the number of gradation sections in the first histogram; and a gradation correction step of performing gradation correction processing using the second histogram when it is determined in the decision processing that the image contains a low-contrast region, and of performing gradation correction processing using the first histogram when it is determined that the image does not contain a low-contrast region.

### BRIEF DESCRIPTION OF THE SEVERAL VIEWS OF THE DRAWINGS

FIG. 1 is a diagram showing, in outline, the overall configuration of an image-processing apparatus according to a first embodiment of the present invention.

FIG. 2 is a flowchart showing the flow of gradation correction processing of an image in an image acquisition apparatus of the present invention.

FIG. 3 is a diagram showing an example of a first histogram calculated in a first gradation-distribution calculating unit in the image processing apparatus of the present invention.

FIG. 4 is a graph showing a gradation conversion characteristic calculated from the first histogram.

FIG. 5 is a diagram showing an example of a second histogram calculated in a second gradation-distribution calculating unit of the present invention.

FIG. 6 is a graph showing a gradation conversion characteristic calculated from the second histogram.

FIG. 7 is a diagram showing, in outline, the overall configuration of an image acquisition apparatus according to a second embodiment of the present invention.

### DETAILED DESCRIPTION OF THE INVENTION

Embodiments of an image processing apparatus, an image processing method, and an image processing program according to the present invention will be described below with reference to the drawings.

### First Embodiment

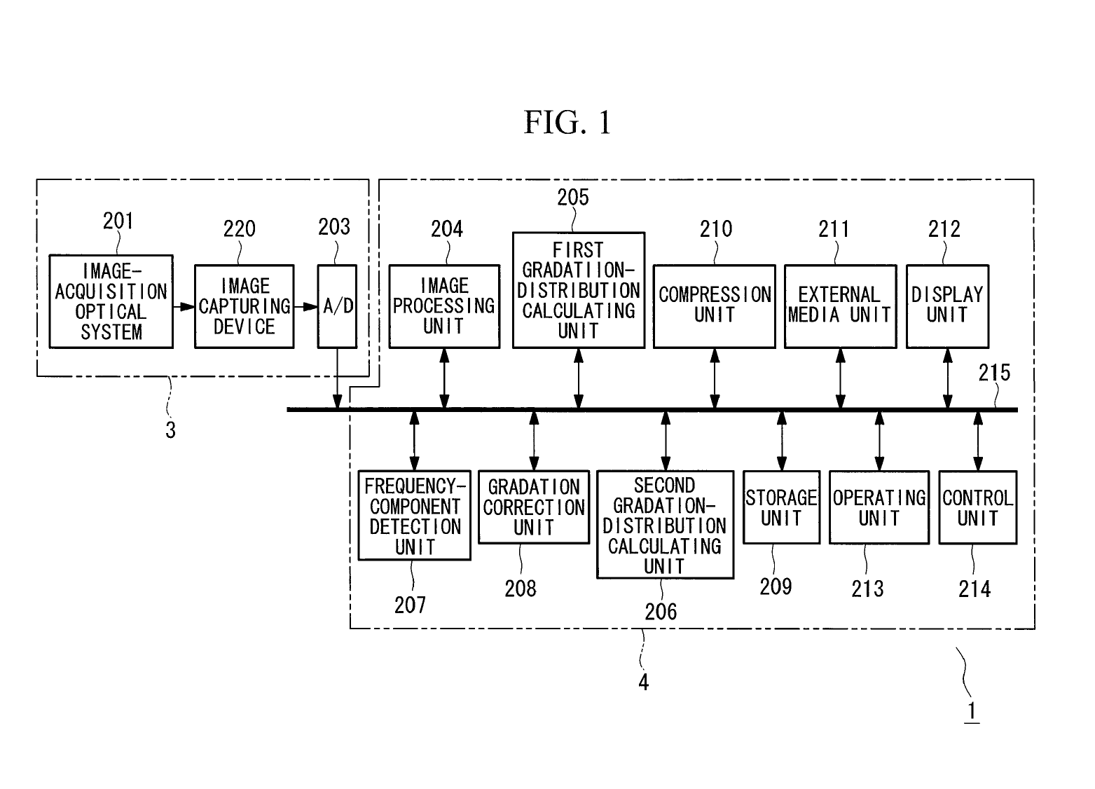

FIG. 1 is a block diagram showing, in outline, the configuration of an image acquisition apparatus 1 according to a first embodiment.

The image acquisition apparatus 1 according to the present invention, for example, a digital camera system, includes an image acquisition section 3 and an image processing apparatus 4. The image acquisition section 3 includes an image-acquisition optical system 201, an image capturing device (image sensor) 202, and an analog-to-digital (A/D) converter 203. The image-acquisition optical system 201 is provided with an image-capturing lens for focus adjustment, a stop for adjusting the aperture size, a filter for adjusting the brightness, and so forth.

The image capturing device 202 photoelectrically converts an image of the subject formed by the image-acquisition optical system 201 into an electrical signal. Examples of the image capturing device 202 include two-dimensional image capturing devices such as CCDs or CMOS imaging devices.

The analog image signal captured by the image capturing device 202 is converted to a digital signal by the A/D converter 203 and is input to the image processing apparatus 4.

The image processing apparatus 4 includes an image processing unit 204, a first gradation-distribution calculating unit 205, a second gradation-distribution calculating unit 206, a frequency-component detection unit (decision unit) 207, a gradation correction unit 208, and other components. These units are connected to each other via a data bus 215 in the image processing apparatus 4.

The image processing unit 204 subjects the image signal converted to a digital signal by the A/D converter 203 to various kinds of enhancement processing, such as color-separation processing, white balance processing, color correction processing, and distortion correction processing.

After the image signal has been subjected to enhancement processing, the first gradation-distribution calculating unit 205 divides the gradation range of the input image signal into a plurality of gradation sections and calculates a first histogram showing each gradation section and the frequency of pixel values in each gradation section.

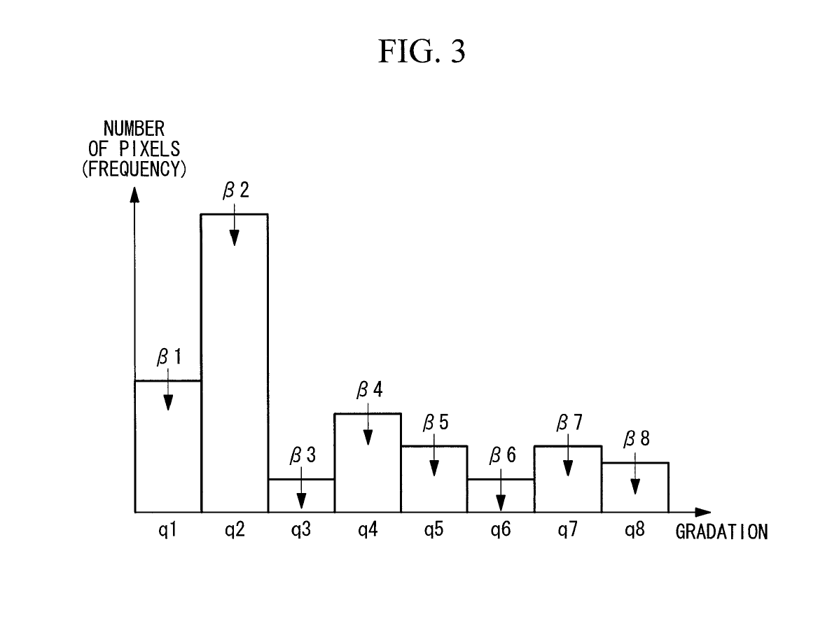

FIG. 3 shows an example of the first histogram when the gradation range is divided into eight sections. In FIG. 3, the horizontal axis shows the gradation, and the vertical axis shows the number of pixels (frequency). For example, in the case of 256 gradations, the gradation range is divided into sections of 32 gradations each: an initial section q1 with gradation levels 0 to 31, a second section q2 with gradation levels 32 to 63, and so on. Although FIG. 3 shows the case of eight gradation sections, the number of gradation sections is not limited thereto.

The frequency-component detection unit 207 detects a feature component signal, related to the image contrast, from the image signal subjected to enhancement processing by the image processing unit 204. In this embodiment, a frequency component serving as the feature component signal related to the image contrast is detected. By detecting the frequency component in this way, it is possible to detect a region where the contrast variation is small, for example, a human face or hair, a blue or cloudy sky, or a wall of a single color. Then, based on the detected frequency component, the frequency-component detection unit 207 determines whether or not the image contains a low-contrast region with a contrast lower than a prescribed threshold. More specifically, the frequency-component detection unit 207 performs frequency component detection by subjecting a three-plane image signal to low pass filtering (LPF). Accordingly, high-frequency components in the image signal are removed, yielding a smooth image signal containing low-frequency components. Next, the frequency-component detection unit 207 calculates the difference between the three-plane image signal and the low-frequency component image signal from which the high-frequency components have been removed, and if there are pixels for which this difference is lower than a prescribed threshold, it determines that the image contains a low-contrast region, in other words, a region where there is not much contrast with the surroundings.

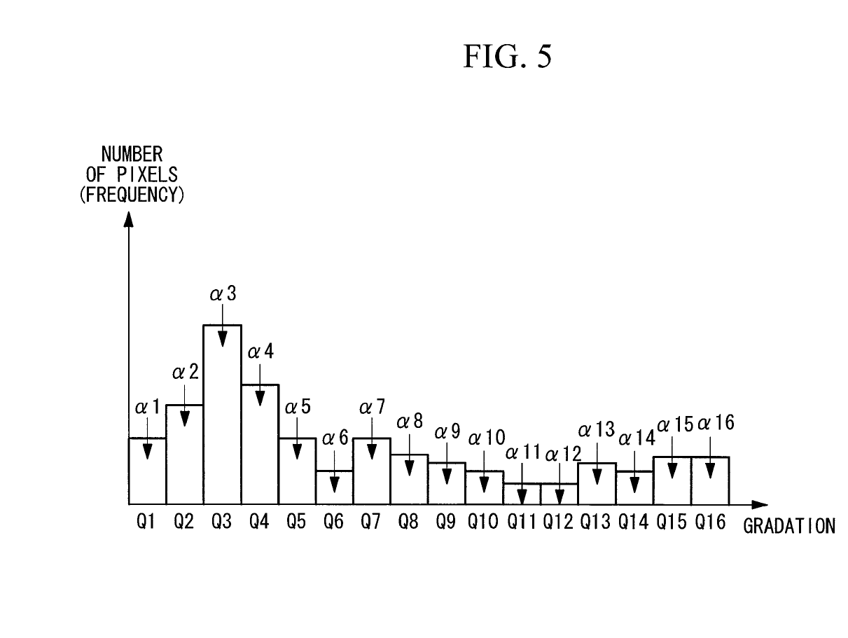

When it is determined by the frequency-component detection unit 207 that the image contains a low-contrast region, the second gradation-distribution calculating unit 206 calculates a second histogram in which the gradation range of the input image signal is divided into a greater number of sections than the number of gradation sections in the first histogram. More specifically, the second gradation-distribution calculating unit 206 derives the second histogram by calculation based on the first histogram by more finely dividing the gradation range of the first histogram created by the first gradation-distribution calculating unit 205. FIG. 5 shows an example of the second histogram calculated in the second gradation-distribution calculating unit 206. In FIG. 5, the horizontal axis shows the gradation, and the vertical axis shows the number of pixels (frequency). Although FIG. 5 shows a case where the gradation range is divided into 16 sections, the number of gradation sections is not limited thereto. The method of calculating the second histogram will be described in detail below.

When it is determined by the frequency-component detection unit 207 that the image contains a low-contrast region, the gradation correction unit 208 performs gradation correction processing using gradation correction values created on the basis of the second histogram. When it is determined that the image does not contain a low-contrast region, the gradation correction unit 208 performs gradation correction processing using gradation correction values created on the basis of the first histogram.

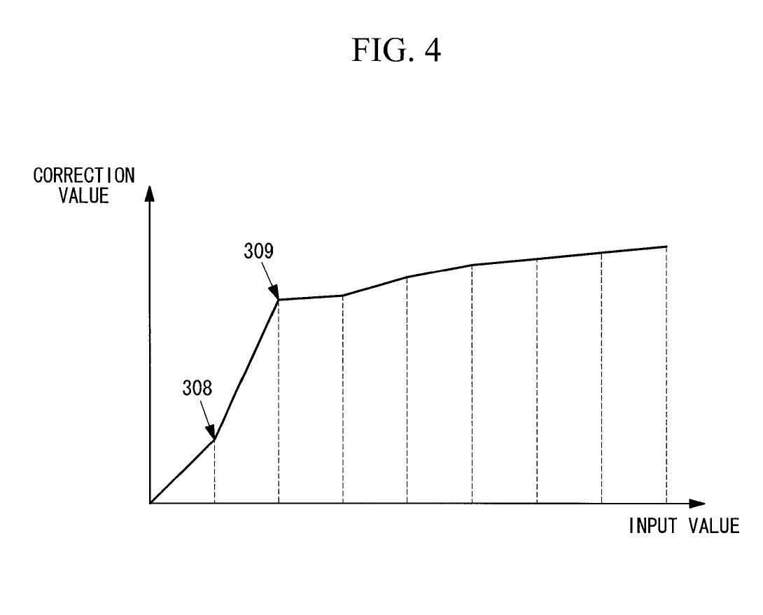

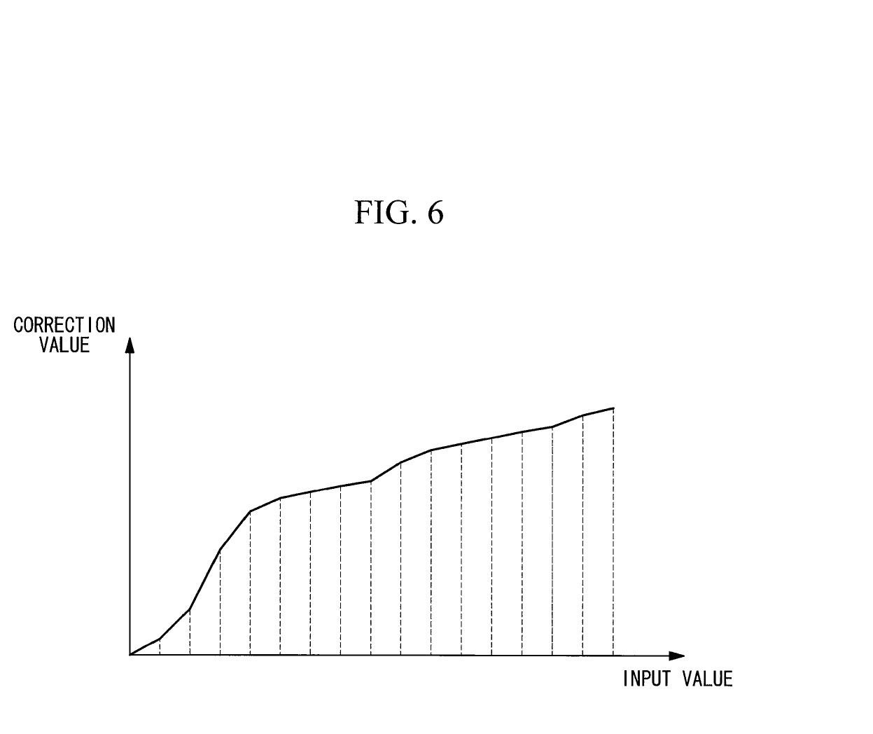

A gradation conversion characteristic calculated from the first histogram is shown in FIG. 4, and a gradation conversion characteristic calculated from the second histogram is shown in FIG. 6.

In addition to the above-described elements, a storage unit (memory) 209, a compression unit 210, an external media unit 211, a display unit 212, an operating unit 213, and a control unit 214 are connected to the data bus 215.

The storage unit 209 is a memory for temporarily storing the image signal digitally converted by the A/D converter 203, the image signal subjected to enhancement processing by the image processing unit 204, the first histogram calculated by the first gradation-distribution calculating unit 205, the second histogram calculated by the second gradation-distribution calculating unit 206, and a compressed image processed in the compression unit 210, which is described later.

The compression unit 210 compresses the image data stored in the storage unit 209 using JPEG compression, or the like. The image compression is not limited to JPEG, and another compression method may be employed.

The external media unit 211 is provided with a media drive that reads or writes image data from or to external media. The external media is a rewritable storage medium such as an xD Picture Card (trade name), Compact Flash (trade name), SD Memory (trade name), Memory Stick (trade name), or a hard disk drive etc., and it can be mounted in and removed from the image acquisition apparatus.

The display unit 212 is a display monitor that displays the image data stored in the storage unit 209 or the external media 211. The display unit 212 is, for example, a liquid crystal display device disposed on the rear face of the image acquisition apparatus main body. However, the position is not limited to the rear face so long as the photographer can view it. Also, it is not limited to a liquid crystal device; another display device may be used.

The operating unit 213 is provided with buttons or switches for the user to operate the image processing apparatus 4, an information display unit, and so forth.

The control unit 214 controls the image-acquisition optical system 201, the image capturing device 202, the image processing unit 204, etc. according to a prescribed sequence that is stored in advance or input by user operations via the operating unit 213.

Next, the method of calculating the second histogram from the first histogram will be described. In this embodiment, the frequency of pixel values in a gradation section of the first histogram corresponding to gradation sections in the second histogram and a frequency of pixel values in a gradation section neighboring (in this embodiment, the section with larger gradation values is used) that gradation section are obtained, and by performing weighted averaging on these frequency values, the frequencies of the pixel values in the gradation sections in the second histogram are calculated.

For example, the calculation formulae used in the second gradation-distribution calculating unit 206 in the case where a second histogram having 16 gradation sections (FIG. 5) is calculated from the first histogram having eight gradation sections (FIG. 3) are shown below. The values α1 to α16 are the frequencies of the respective gradation sections Q1 to Q16 in FIG. 5, and the values β1 to β8 are the frequencies of the respective gradation sections q1 to q8 in FIG. 3.

α1=(β1*½)

α2={(β1*¾)+(β2*¼)}½

α3={(β2*¾)+(β1*¼)}½

α4={(β2*¾)+(β*¼)}½

α5={(β3*¾)+(β2*¼)}½

α6={(β3*¾)+(β4*¼)}½

α7={(β4*¾)+(β3*¼)}½

α8={(β4*¾)+(β5*¼)}½

α9={(β5*¾)+(β4*¼)}½

α10={(β5*¾)+(β6*¼)}½

α11={(β6*¾)+(β5*¼)}½

α12={(β6*¾)+(β7*¼)}½

α13={(β7*¾)+(β6*¼)}½

α14={(β7*¾)+(β8*¼)}½

α15={(β8*¾)+(β7*¼)}½

α16=(β8*½)

Because the second histogram is calculated by a simple computation from the first histogram in this way, the amount of computation is small, and it is thus possible to perform the gradation correction processing easily. The number of gradation sections of the second histogram is preferably a power-of-two multiple of the number of gradation sections in the first histogram. With this arrangement, it is possible to calculate the second histogram with simple calculation formulae.

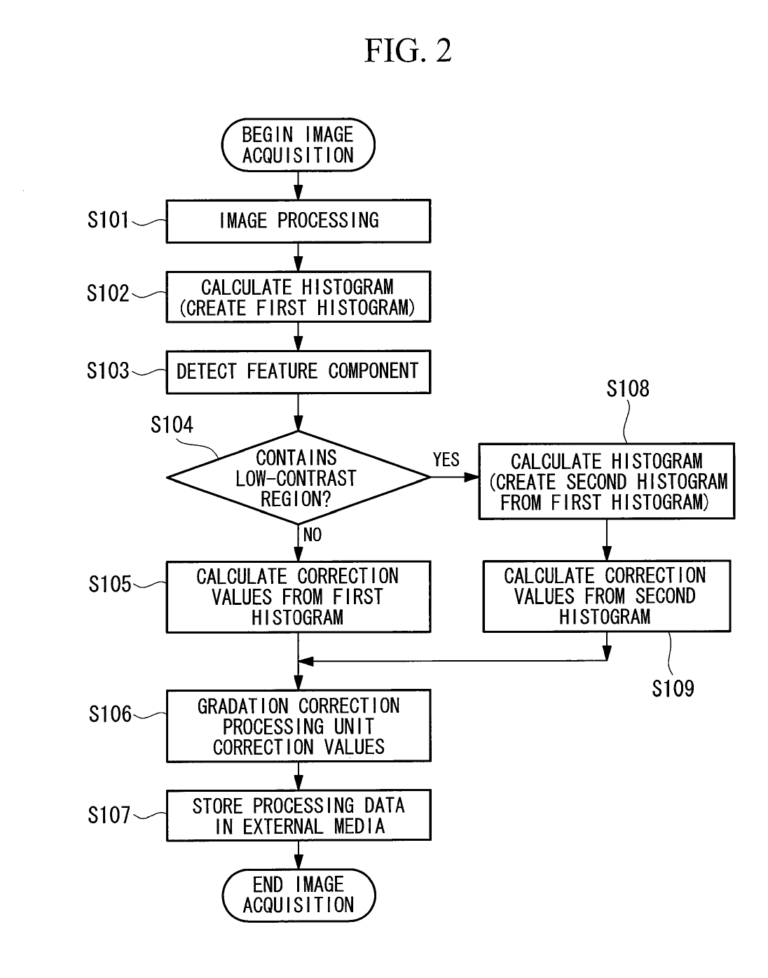

Next, the operation of the image acquisition apparatus according to this embodiment will be described with reference to FIGS. 2 to 6.

FIG. 2 is a flowchart showing the flow of gradation correction processing of an image in the image acquisition apparatus according to this embodiment.

The optical image acquired by the image-acquisition optical system 201 is converted to an analog image signal in the image capturing device 202, and is then converted to a digital signal by the A/D converter 203. This digitized image signal is sent to the storage unit 209.

Single-plane image signals stored in the storage unit 209 are sent to the image processing unit 204 where various kinds of enhancement processing are performed, such as color-separation processing, white balance processing, etc., and an RGB three-plane image signal is created (step S101 in FIG. 2). This image signal may then be subjected to color correction processing, distortion correction processing, etc. The three-plane image signal processed in the image processing unit 204 is sent to the storage unit 209.

Next, the three-plane image signal stored in the storage unit 209 is read out by the first gradation-distribution calculating unit 205, and the first histogram is calculated using this three-plane image signal (step S102 in FIG. 2). The first histogram created in this way is sent from the first gradation-distribution calculating unit 205 to the storage unit 209.

Next, the three-plane image signal stored in the storage unit 209 is read out by the frequency-component detection unit 207, frequency components are detected from this three-plane image signal (step S103 in FIG. 2), and by using the detection result, it is determined whether or not the image signal contains a low-contrast region (step S104 in FIG. 2).

If it is determined that the image does not contain a low-contrast region, the first histogram results and the three-plane image signal stored in the storage unit 209 are read out by the gradation correction unit 208, and a gradation conversion characteristic is created using the first histogram (step S105 in FIG. 2). Then, gradation correction processing of the input image signal is performed using this gradation conversion characteristic (step S106 in FIG. 2). The image signal subjected to gradation correction processing is sent to the compression unit 210 where it is compressed, for example, to a JPEG-format image signal or the like, after which it is stored on the external media in the external media unit 211 (step S107 in FIG. 2), thus completing the processing.

In step S104, if it is determined that the image contains a low-contrast region, the first histogram results and the three-plane image signal stored in the storage unit 209 are read out by the second gradation-distribution calculating unit 206, and a second histogram in which the gradation range is divided into a greater number of gradation sections than the first histogram is calculated based on this first histogram (step S108 in FIG. 2). The second histogram calculated in this way is stored in the storage unit 209.

Next, the second histogram results and the three-plane image signal stored in the storage unit 209 are read out by the gradation correction unit 208, and a gradation conversion characteristic is created on the basis of the second histogram results (step S109 in FIG. 2). Then, gradation correction processing of the image signal is performed using this gradation conversion characteristic (step S106 in FIG. 2). The image signal subjected to gradation correction processing is then sent to the compression unit 210 where it is compressed, for example, to a JPEG-format image signal or the like, after which it is stored in the external media in the external media unit 211 (step S107 in FIG. 2), thus completing the processing.

As described above, with the image processing apparatus according to this embodiment, because the second histogram is formed of more sections than the number of gradation sections in the first histogram, the gradation conversion characteristic created on the basis of this second histogram has more moderate correction level variations compared with the gradation conversion characteristic created using the first histogram.

For example, when a low-frequency region having small contrast variations is contained in the image signal, if gradation correction processing based on the first histogram were performed, the amount of correction would be too great. Therefore, the amount of correction in gradation sections where pixels of the image data do not exist (or are extremely small) would be considerably increased, thereby causing black pixels to become lighter or causing a reduction in the brightness of white pixels. Therefore, color unevenness may end up being emphasized.

Accordingly, by subjecting such an image to gradation correction processing on the basis of the second histogram whose variation in the amount of correction is more moderate than that of the first histogram, it is possible to suppress color unevenness in the image, even for an image containing a low-contrast region, and it is thus possible to output a natural-looking image.

Because the frequency-component detection unit 207 calculates the second histogram only for the case where it is determined that the image contains a low-contrast region, it is possible to omit the processing for calculating the second histogram when it is determined that the image does not contain a low-contrast region, allowing the amount of processing to be minimized.

In this embodiment, the frequency-component detection unit 207 detects the low-frequency component by applying a low-pass filter to the image signal and determines whether the image contains a low-contrast region on the basis of this low-frequency component. Instead of this, however, the frequency component detection unit 207 may obtain an image from which the low-frequency component has been removed, that is, an image containing a high-frequency component, by applying a high-pass filter (HPF) to the image signal, and may determine that the image contains a low-contrast region on the basis of this high-frequency component.

More specifically, a high-frequency-component image from which the low-frequency component has been removed is extracted in the frequency-component detection unit 207. When this high-frequency-component image signal is 0 or less than a prescribed threshold that is set in advance, it does not contain a high-frequency-component signal, and therefore, it is determined that the image contains a low-contrast region.

In this embodiment, the first histogram, the second histogram, and so forth are temporarily stored in the storage unit 209, and when this information is to be used, the necessary information is read out from the storage unit 209. Instead of this, however, the following arrangement may be employed.

For example, when the gradation correction unit 208 reads out the first histogram stored in the storage unit 209 and determines that the image contains a low-contrast region, the first histogram is sent from the gradation correction unit 208 to the second gradation-distribution calculating unit 206. When the second histogram is created in the second gradation-distribution calculating unit 206, this second histogram is sent to the gradation correction unit 208, and gradation correction processing is performed in the gradation correction unit 208 using this second histogram.

### Second Embodiment

Next, a second embodiment of the present invention will be described with reference to the drawings.

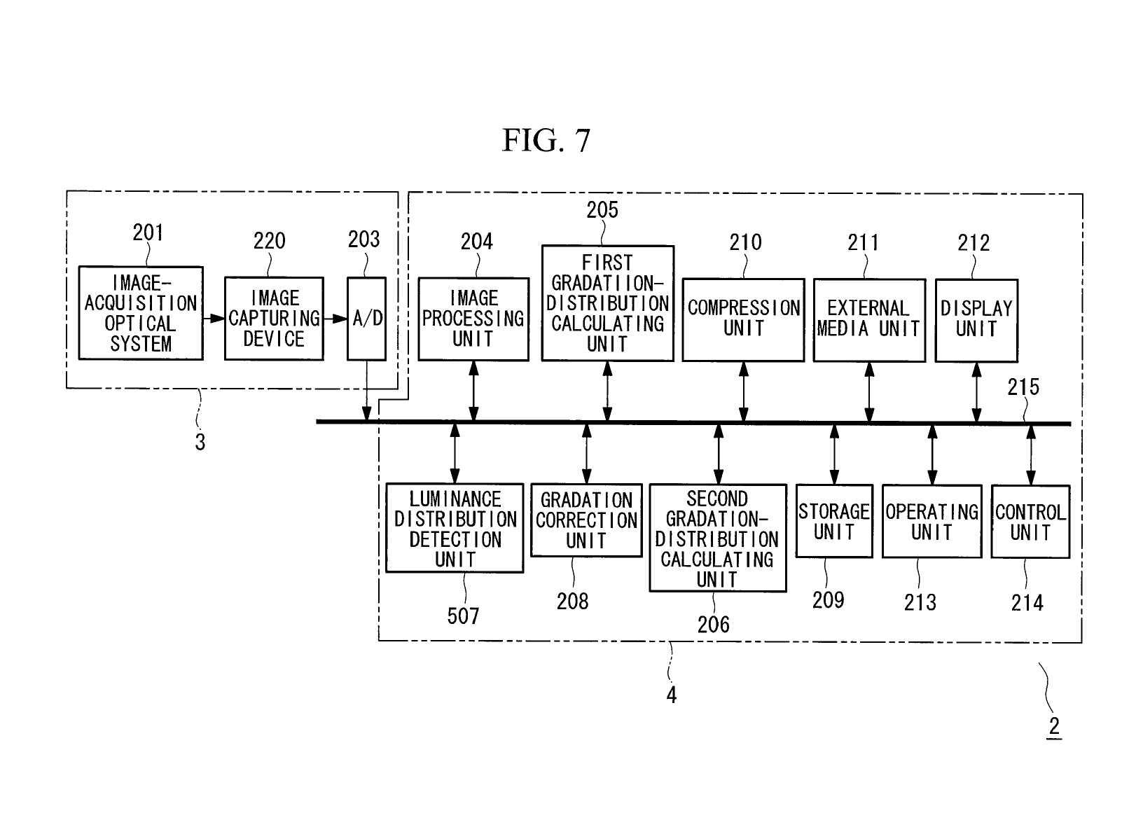

FIG. 7 is a block diagram showing, in outline, the configuration of an image acquisition apparatus 2 according to a second embodiment.

A description of commonalties with the image processing apparatus 1 according to the first embodiment described above will be omitted, and mainly the differences will be described here.

In the image processing apparatus 4 according to the first embodiment described above, it is determined whether the image contains a low-contrast region by detecting frequency components in the frequency-component detection unit 207. In contrast, in the image processing apparatus 2 according to this embodiment, instead of the frequency-component detection unit 207, a luminance-distribution detection unit (decision unit) 507 is provided, and it is determined whether the image contains a low-contrast region on the basis of a luminance distribution. More specifically, the luminance-distribution detection unit 507 reads out a three-plane image signal stored in the storage unit 209 and calculates a luminance value Y at each pixel. The luminance value Y is given by the following formula.

Y=0.299R+0.587G+0.144B

The luminance-distribution detection unit 507 then extracts the maximum value and minimum value of the luminance Y in the image and calculates the difference between the maximum value and the minimum value. Then, this difference is compared with a prescribed threshold that is set in advance, and if the difference is smaller than the prescribed threshold that is set in advance, it is determined that the image contains a low-contrast region.

When it is determined by the luminance-distribution detection unit 507 that the image does not contain a low-contrast region, gradation correction processing is performed using the first histogram, and when it is determined that the image contains a low-contrast region, gradation correction processing is performed using the second histogram.

What is claimed is:

1. An image processing apparatus comprising:
a first gradation-distribution calculating unit that divides the gradation range of an input image signal into a plurality of gradation sections and that calculates a first histogram showing the frequency of pixel values in each gradation section;
a decision unit that detects a feature component signal related to the contrast of an image from the input image signal and that determines, on the basis of the feature component signal, whether the image contains a low-contrast region whose contrast is lower than a prescribed threshold;
a second gradation-distribution calculating unit that calculates, using the first histogram, a second histogram in which the gradation range of the input image signal is divided into a greater number of sections than the number of gradation sections in the first histogram; and
a gradation correction unit that performs gradation correction processing using the second histogram when it is determined by the decision unit that the image contains a low-contrast region, and that performs gradation correction processing using the first histogram when it is determined that the image does not contain a low-contrast region.

2. An image processing apparatus according to claim 1, wherein the second gradation-distribution calculating unit calculates the second histogram when the decision unit determines that there is a low-contrast region.

3. An image processing apparatus according to claim 1, wherein the feature component signal is a frequency component.

4. An image processing apparatus according to claim 1, wherein the feature component signal is a difference between a maximum value and a minimum value of luminance values in a luminance distribution of the input image signal.

5. An image processing apparatus according to claim 1, wherein the number of gradation sections in the second histogram is a power-of-two multiple of the number of gradation sections in the first histogram.

6. An image acquisition system comprising:
an image acquisition section that acquires an image; and
an image processing apparatus according to claim 1, which subjects the image acquired by the image acquisition section to gradation correction processing.

7. A program storage medium storing an image processing program that causes a computer to execute:
first gradation-distribution calculation processing for dividing the gradation range of an input image signal into a plurality of gradation sections and calculating a first histogram showing the frequency of pixel values in each gradation section;
decision processing for detecting a feature component signal related to the contrast of an image from the input image signal and for determining, on the basis of this feature component signal, whether the image contains a low-contrast region whose contrast is lower than a prescribed threshold;
second gradation-distribution calculation processing for calculating, using the first histogram, a second histogram in which the gradation range of the input image signal is divided into a greater number of sections than the number of gradation sections in the first histogram; and
gradation correction processing for performing gradation correction processing using the second histogram when it is determined in the decision processing that the image contains a low-contrast region, and for performing gradation correction processing using the first histogram when it is determined that the image does not contain a low-contrast region.

8. An image processing method comprising:
a first gradation-distribution calculation step of dividing the gradation range of an input image signal into a plurality of gradation sections and calculating a first histogram showing the frequency of pixel values in each gradation section;
a decision step of detecting a feature component signal related to the contrast of an image from the input image signal and determining, on the basis of this feature component signal, whether the image contains a low-contrast region whose contrast is lower than a prescribed threshold;
a second gradation-distribution calculation step of calculating, using the first histogram, a second histogram in which the gradation range of the input image signal is divided into a greater number of sections than the number of gradation sections in the first histogram; and
a gradation correction step of performing gradation correction processing using the second histogram when it is determined in the decision processing that the image contains a low-contrast region, and of performing gradation correction processing using the first histogram when it is determined that the image does not contain a low-contrast region.
